(19) United States
(12) Patent Application Publication
(10) Pub. No.: US 2026/0336245 A1
(43) Pub. Date: Oct. 29, 2026

(54) A MANIPULATION DEVICE FOR FOLDING PRODUCTS AND ASSOCIATED METHODS

(71) Applicant: Anheuser-Busch InBev S.A., Brussels (BE)

(72) Inventors: Tom VAN MOER, Hamme (BE); Manu PEELMAN, Hamme (BE)

(21) Appl. No.: 19/099,006

(22) PCT Filed: Jul. 26, 2023
(86) PCT No.: PCT/EP2023/070772

§ 371 Date: Jan. 27, 2025

(30) Foreign Application Priority Data
Jul. 27, 2022 (BE) 2022/5602

(51) Int. Cl. B31B 50/00

(52) U.S. Cl. CPC B31B 50/0044

(57) ABSTRACT

A manipulation device for folding products comprising an input; and an output; the manipulation device defining a product pathway between the input and the output; the manipulation device further comprising: a transportation device configured to move a product along the product pathway; a first gas manipulator associated with the product pathway, nozzle of the first gas manipulator configured to output pressurized gas in a first orientation with respect to the product pathway for manipulating a product on the transportation device; a second gas manipulator associated with the product pathway, nozzle of the second gas manipulator configured to output pressurized gas in a second orientation with respect to the product pathway for manipulating the product on the transportation device, the second orientation being different to the first orientation.

### FIELD

The present invention relates to a device and associated methods of folding a product, in particular secondary packaging, for example for fast-moving consumer goods, such as beverages in cans and bottles.

### BACKGROUND

Manufacturing, assembly and distribution of many products requires the high-capacity folding of part of a product with respect to the rest of the product. One example of this is the erection and closure of packaging. Large scale manufacturing is characterised by high-capacity packaging of objects or goods of varying shapes and sizes, with those objects typically being purchased in groups and as such packaged in bundles, cases, crates, baskets, cartons, boxes, totes, and the like (with the objects usually being grouped by same or similar size, shape, colour, material types, mass, etc.). Demands on manufacturing operations, in particular in the fast-moving consumer goods (FMCG) field are characterized by high range, high capacity, and efficient changeover, to name a few.

Presently, conventional high-capacity machines can typically exhibit high output, but only across a limited range of objects configurations, e.g. objects of a certain size or shape, and with said objects only being able to be grouped in a small range of predefined grouping numbers. Conventional packaging assembly lines therefore typically require extensive use of change parts to accommodate the packaging of different size and/or configurations (patterns and quantities) of objects. This ultimately impacts capital equipment and operational costs, the amount of conveying required, the amount of factory real estate, personnel, utility consumptions and productivity etc.

Traditionally, manipulation of packaging happens in a mechanical way, for example using rotating tuckers, pushers, mandril and mold (cavity) plunge form tooling, folding rails, flap-folding arms and/or ploughs to close or otherwise manipulate foldable and/or wrappable, packaging flaps (panels). These mechanical means often require extended lengths of conveyor over which to effect the closing of flaps, taking time and—critically—invoking machine length and thus requiring much in the way of factory real estate.

A secondary disadvantage of using mechanical means for manipulating packaging is that the collision between the packaging and the manipulation element (e.g. an arm), which is necessary to manipulate the packaging introduces the risk of damage to the packaging or whatever is contained within.

Importantly, in all production lines, the speed of a product, such as secondary packaging, along a production line coupled with the time taken to manipulate the product (e.g. packaging) into a desired configuration dictates the length of the machine and/or production line. The length of the production line has a knock-on effect of dictating the factory space required to house the production line, with larger factory spaces being of greater cost. Therefore, it is desirable for foldable-products such as packaging to be assembled in as short time as possible, ultimately providing as short a production line as possible, thereby minimising space required and factory costs.

### SUMMARY

The present disclosure provides a device and method for manipulating products, specifically products capable of being folded (i.e. a “foldable-product”)—such as secondary packaging (e.g. cardboard containers)—at high capacity and in as short a travel distance (and hence machine length) as possible, without the need for change parts.

The present disclosure relates to a manipulation device for use with any foldable and/or wrappable product. A particularly relevant example of such products is packaging, specifically secondary packaging. Other examples of products include toys, marketing material or point of sale displays. References made herein to “packaging”, “packaging product” or “secondary packaging” are to be understood to apply equally to other foldable and/or wrappable products unless explicitly stated to the contrary.

The present disclosure further provides a device and method for manipulating packaging; thereby avoiding the use of mechanical manipulation means that contact the packaging during assembly, which could impact the packaging by shear forces and bring a real risk of damaging the packaging. The manipulation of the packaging is carried out using pressurised gas.

Given that the invention of the present disclosure does not use mechanical components tailored to and contacting a packaging to manipulate it into a desired state of assembly, the production line has a greater degree of flexibility; the key benefit being that the need for change parts is eliminated. For example, the components on the production line that perform the required manipulations may simply and quickly be repositioned, reoriented and/or reconfigured for packaging of new dimensions introduced on the production line. The elimination of the need for change parts thus greatly increases the range of different types of packaging that can be manipulated, and greatly reduces the downtime required to changeover machine setups between different product runs and significantly reduces the real estate required (e.g. to store change parts).

The reorientation and/or reconfiguration of the components on the production line that perform the required manipulations may be automated and directed to previously determined pack specific configurations according to a menu item selected via the operator interface control panel (HMI). Optimized performance of any setup and/or the operation of such may be realized via artificial intelligence, further helping to increase the efficiency, precision and performance of the device. This also provides a safer device, as no human contact is required in the reconfiguration of the production line components via the exchange of change parts to suit alternate packaging configurations and product contact and moving mechanical mechanism are avoided in favour of no moving parts, contactless (mechanically) devices.

In particular, when using gas manipulators as the components on the production line to manipulate packaging, a much faster manipulation could be observed. More rapid packaging manipulation operations allows higher machine throughput, as more operations can be completed within a given period. It also reduces the overall size of a packaging line, since the same manipulation can be completed within a shorter distance as a packaging moves through a production process. This allows packaging lines to be more compact, reducing floor space needed and factory space required to house the production line(s), and hence reducing real estate costs.

Manipulating a product using devices according to the disclosure avoids manipulator components encroaching on to any pathway on which a packaging is being moved from an input to an output; thereby reducing the risk of damage to packaging or an operator.

An aspect of the present disclosure relates to a manipulation device. The device comprises an input; and an output; the manipulation device defining a product pathway between the input and the output; the manipulation device further comprising: a transportation device (e.g. a conveyor or mover) configured to precisely move a product along the product pathway; wherein the product pathway defines a machine direction along which the product moves from the input to the output. The device further comprises a gas manipulator arranged about the product pathway, configured to output pressurised gas for manipulating the packaging product on the transportation device.

A manipulation device for folding products comprising: an input; and an output. The manipulation device defines a product pathway between the input and the output. The manipulation device further comprises: a transportation device (e.g. a conveyor, mechanism or independent mover) configured to move a product along the product pathway. The manipulation device also comprises a first gas manipulator associated with the product pathway, configured to output pressurized gas in a first orientation with respect to the product pathway for manipulating a product (e.g. while stationary or in transit between the input and the output) on the transportation device. The manipulation device also comprises a second gas manipulator associated with the product pathway, configured to output pressurized gas in a second orientation with respect to the product pathway for manipulating the product, (.e.g. while stationary or in transit between the input and the output on the transportation device, the second orientation being different to the first orientation.

A packaging may be any container, carton, case, box, envelope, bag, wrap or other container or means of holding together or in position measure, derived from folding and/or wrapping a sheet type material into a two or three-dimensional shape.

The manipulation device according to the disclosure may be configured to receive products—e.g. packages—in an unfolded arrangement and output products in a folded arrangement. The manipulation device may be a standalone device or form part of a larger production line, in which the device may receive products from a preceding apparatus such as a product packing apparatus, and output products to a following apparatus, such as a product stacking apparatus or transportation apparatus.

The manipulation device provided in this manner allows products on the product pathway to be manipulated into a desired pre-defined intermediate or final configuration. For example, a packaging may initially be provided at the input of the pathway in a flat, unfolded manner (i.e. as a blank). Said blank may then be folded by gas manipulation into a folded or erected configuration in which items or goods are contained therein or which could be inserted. Alternatively, a partially folded packaging may be provided at the input of the pathway, with remaining unfolded parts being folded into a final packaging configuration by gas manipulation, e.g. closing the packaging. These manipulations by gas may be completed at exception speeds, with more uniformly applied forces via distributed non-shear pressures and very much more quickly than previously known in the art.

Where the term “folding” is used herein, it may be broadly interpreted to also include wrapping, bending, latching, holding, pressing, inserting or twisting. It therefore may not be limited to requiring the formation of a sharp edge.

The gas used by the gas manipulators may be any suitable gas for the required function, for example, and preferably, air, more preferably compressed air; but nitrogen, helium or the like may also be used (e.g. for special inert applications).

The means of package transportation through the manipulation device may comprise an alignment means, the alignment means being configured to align the packaging opposite one or more datums relative to the manipulation device.

The alignment means may be configured to align an axis of a packaging with the direction of movement of the product along the product pathway. The alignment means may be configured to align any fold lines on the unassembled/partially assembled packaging perpendicular to the direction of gas output by the first or second gas manipulator. This ensures minimal resistance is provided when the packaging is folded. Any suitable alignment means may be used, such as fixed or dynamic (e.g. rotary) cams, guide rails, bumpers, or the like.

Even though the term ‘fold lines’ has been used in this instance, it will be understood by one skilled in the art that a fold line may be a score line, perforated line imaginary fold line or otherwise precise line upon which preferential hinge-like folding occurs.

The first gas manipulator may be configured to perform a first manipulation of a product on the transportation device (e.g. conveyor or independent mover through the manipulation device); and the second gas manipulator may be configured to perform a second manipulation of the product on the transportation device (e.g. conveyor or independent mover through the manipulation device).

The product may be a packaging product comprising a first and second flap; the first manipulation may be folding the first flap and the second manipulation may be folding the second flap.

The first flap may be folded in a first direction, the second flap may be folded in a second direction, different to the first direction.

In some examples a manipulation may be only part of the process of folding a flap. For example a first manipulation may comprise starting the process of folding a flap and the second manipulation comprise finishing the process of folding a flap and thus also holding also the former folded flap in place.

Having first and second gas manipulators as part of the manipulation device means multiple manipulations can be performed on a packaging (or other product) without having to reorient the packaging on the product pathway, or the gas manipulators about the product pathway. There is no mechanical movement and no inertia to overcome or return stroke to accommodate of any reciprocating device. This, together with the sheer speed of actuation of gas manipulation device, greatly increases the operation speed and thus capacity of the manipulation process according to the disclosure, compared to existing systems.

The first and second gas manipulators may be configured to manipulate a product on the transportation device (e.g. conveyor or mover) while in transit. That is, the gas manipulators may be configured to manipulate the product as the product moves along the product pathway.

The manipulation device may comprise a gas manipulator configured to make sure that the leading and/or trailing edge of a packaging is flat (straight). This ensures minimized and more consistent resistance to fold or bend initiation and to a reliable, accurate and precise operation.

The first gas manipulator may comprise a nozzle. The nozzle of the first gas manipulator may be configured to output pressurized gas (e.g. in the first orientation with respect to the product pathway). The second gas manipulator may comprise a nozzle. The nozzle of the second gas manipulator may be configured to output pressurized gas (e.g. in the second orientation with respect to the product pathway).

In order to direct output pressurized gas with a certain orientation, the nozzle itself may be oriented with its output axis along the respective orientation.

The first and/or second gas manipulators may comprise a plurality of nozzles. Each gas manipulator may comprise a plurality of nozzles.

The plurality of nozzles within a single gas manipulator may have different locations with respect to the product pathway; and/or have different orientations with respect to the product pathway; and/or, be configured to output gas having different characteristics defined by at least one of: the nozzle type, the output pressure; the output flowrate; the output area; and the output cross-sectional shape.

The first gas manipulator may be configured to output pressurized gas with a first timing in relation to the location of the product relative to the gas manipulator. The second gas manipulator may be configured to output pressurized gas with a second timing in relation to the location of the product relative to the gas manipulator. The second timing may be different to the first timing.

The plurality of nozzles may be configured to be triggered to operate at different times and durations relative to the position of the pack relative to the manipulation device (and hence to the nozzle) and relative to each other (i.e. nozzle activation sequence).

Within a nozzle set making up a gas manipulator, one or more nozzles may be used to initiate flap folding and overcoming initial resistance to bending, while another one or more nozzles may be focused on driving movement through a major portion of the folding arc, while yet another one or more nozzles may be focused on flattening and holding the then folded flap securely in the folded position. Each nozzle or sub-set of the nozzles making up a gas manipulator being independently configurable in terms of type, orientation, position and operational parameters (i.e. applied gas pressure, start and duration of operation; and sequence of operation if more than one nozzle making a set).

A gas flow orientation may be defined with respect to an x-axis, y-axis and/or a z-axis. The x-axis parallel to the product pathway and may be referred to as the machine direction. The y-axis may be perpendicular to the x-axis and in the horizontal plane of the product pathway; the y-axis may be transverse to the machine direction. The z-axis may be perpendicular to the x and the y axis.

The first orientation may be arranged in a plane parallel to the product pathway for folding a first flap of a product and the second orientation may be arranged in a plane perpendicular to the product pathway for folding a second flap of the product in a direction perpendicular to that of the first flap.

The first orientation may be arranged in the x-z plane. The second orientation may be arranged in the y-z plane.

The first gas manipulator and the second gas manipulator may be configured to generate a gas output having different characteristics. The characteristics of the gas output may be defined by at least one of: the output pressure, the output flowrate, the output area, position, number of nozzles or outlets, duration of output and the output cross-sectional shape of the gas flow.

The nozzle(s) of the first gas manipulator and the nozzle(s) of the second gas manipulator may be configured to generate a gas output having different package manipulation potencies and characteristics. The manipulation potency and characteristics of a gas manipulator and more specifically an individual or sub-set of nozzles may be defined by at least one of: the nozzle proximity, orientation and/or inclination to the foldable packaging material flap at the moment of activation and through the period (duration) of operation; the output pressure; the output flowrate, area and cross-sectional shape as defined by the nozzle type, the sequence and moment of activation and duration of activation(s) relative to the pack position (typically while in transit) through the manipulation device.

Pack specific flap folding performance may be achieved by altering the position, inclination and/or orientation or one or more nozzles making up a gas manipulator, as well as the characteristics, timing, duration and firing sequence of the nozzle profiles, thereby achieving an increased pressure (force) and/or different cross-sectional area of the released gas, for example. Further the initiation of the gas manipulation sequence of the second gas manipulator relative to the operational sequence of the first gas manipulator may also be configured that while the first flap folding operation is occurring, the second operation is already initiated that the second operation secures and retains the completion of the first operation.

The or each gas manipulator may be configured to move between a first and second arrangement. A first arrangement may be associated with a first manipulation, the second arrangement may be associated with a second manipulation. For example the or each gas manipulator may be configured to move between different arrangements between product runs, in order to undertake different actions for each run, or to complete the same action for different products (e.g. on different packaging). This reconfiguration may be controlled by the controller.

The gas manipulators, or nozzles thereof, may be reconfigurable. That is, the gas manipulators or nozzles may be configured to modify the characteristics of the flap manipulation effect. As the manipulators/nozzle output is reconfigurable, the device may be used with a wide variety of packaging and may undertake a range of different manipulations. For example, packaging of differing heights, widths and lengths; and thus also packaging material calipers (panel stiffness and increase in folding resistance per unit length), foldable panel dimensions and thus greater areas and score line lengths; may be manipulated on the product pathway stationary or while in transit and without changing parts. Alternatively, or additionally, different materials may be used with the device that have differing resistances to manipulation, e.g. folding and/or bending.

The manipulation devices may be arranged on, adjacent, about or above the product pathway and/or transportation device.

The manipulation device may comprise reconfigurable robotic arms, arranged to support the gas manipulators and/or nozzles thereof. This arrangement may allow quick reconfiguration of the gas manipulators (e.g. in preparation to manipulate a different type of product (e.g. primary product type, size (diameter & height), count and pattern within the package).

The manipulation device may comprise slide actuators. The gas manipulators and/or nozzle(s) of the gas manipulators may be arranged on slide actuators for positioning such that adjustments may be made for width (y-axis) and height (z-axis) as well as employ motorized pivot mountings to adjust inclinations about eg. the x-axis.

The product material is preferably paper boards, but may generally be of different material and various types within the understanding of the skilled person, such as raw/unaltered material, laminated material, corrugated material, or the like. Said packaging material may be printed (e.g. with branding) and/or coated (e.g. varnished) on one or both sides. Different resistances to manipulation, like e.g., folding, may be provided by products formed of different materials, and/or differing grades/construction of the same material. By being able to configure the nozzles, and thereby the gas output, to the specific packaging requirements, a wide variety of packaging products can be manipulated on the manipulator device.

The manipulation device according to the disclosure therefore provides far greater flexibility compared to previous systems and can be used with a wide range of packaging.

The manipulation device may comprise a third gas manipulator and a fourth gas manipulator, wherein the third and fourth gas manipulators are configured to output pressurised gas for manipulating the product on the transportation device (e.g. conveyor or independent mover).

As outlined above, providing further manipulators means additional manipulations can be performed on a packaging as it is moved along the product pathway. For example, for the packaging to be manipulated into its desired state, the packaging may be required to be folded in a number of different directions. Three or more gas manipulators can be provided within the system to increase the number of manipulations that can readily be performed in a given time and close coupled sequence.

The first and fourth gas manipulators may be opposing and in a plane parallel to the product pathway, for manipulating a first pair of opposing flaps (e.g. major inner and outer flaps) of a packaging on the means of transportation (e.g. conveyor or independent mover). The second and third gas manipulators may be opposing and in a plane perpendicular to the product pathway, for manipulating a second pair of opposing flaps (e.g. leading and trailing minor flaps) of the packaging.

Gas manipulators arranged in a manner such as disclosed herein allow for rapid manipulation of a packaging. Multiple manipulators may provide a series of fast successive manipulations, significantly reducing the time to assemble and/or complete a packaging manipulation. Gas manipulators may be used alone or in combination with conventional mechanical folding devices such as hold down rails and/or constantly rotating tuckers for transverse operations relative to the direction of travel through the manipulation device.

Where a plurality of gas manipulators are provided, these may be arranged sequentially along the product pathway, for example such that a product passes the manipulators sequentially. Alternatively, the manipulators may be arranged at a same point along the product pathway, for example such that the product passes the manipulators at the same time (i.e. the sets of gas manipulators may be nested and occupy much of the same space, resulting in a very short machine length to perform complete folding operations).

The device may be configured to sequentially operate gas manipulators for sequentially undertaking manipulation events on the product on the transportation device (e.g. conveyor of independent mover), for example sequentially folding corresponding flaps of a packaging, as the product moves from the input to the output. As outlined above, the device may be configured to enable the gas manipulators to rapidly manipulate a packaging. Additionally, the manipulators are configurable to operate sequentially based upon the packaging to be manipulated. For example, different kinds of packaging may require different sequences of manipulations to fold multiple flaps in different flap orders, to reach a desired state.

Additionally, the packaging manipulation device may be configured so that a neighbouring gas manipulator, starts its operation prior to the completion of the operation by another, previously activated, manipulator. Where a sequentially further operation starts before a previously initiated operation is completed, this allows for the following operation to trap and retain the earlier operations and allows for reduction in the time and hence machine distance taken to manipulate a product, allowing for more compact and affordable machinery.

The output of pressurized gas may be controlled by a valve. The valve may be a solenoid valve. Each gas manipulator may be comprise a valve. Alternatively, each nozzle may comprise a valve. The valves are typically close or near coupled to the nozzle/s and are characterized as being high capacity, fast acting (opening and closing) on/off valves for precise application, maintenance and termination of the supplied air pressure to realize the precise, individual portion of the flap manipulation effect and in a highly predictable and repeatable manner.

Each gas manipulator and/or nozzle may be supplied via a local compressed air reservoir. The reservoir may be serviced by a dedicated or regional or central compressed air pressure regulator that the application pressure of the compressed air nozzle is adjustable (controllable) as part of the manipulation device setup per package to be processed. The pressure regulators are preferably digital that the configuration per pack is incorporated into and thus managed by the controller setting up and operating the manipulation device. The capacity of the reservoir (compressed air receiver) tending to ensure line pressure drops are not experienced and hence sudden and excessive drops in pressure, upon nozzle/s activation.

The gas manipulators may output gas at between 1 and 8 bar. A gas manipulation nozzle or gas manipulator may be used to hold back (or open) one or more flaps while another one or more flaps are being folded or production operation executed. Use different types of gas nozzle may be considered, from low through high gas flow capacity and of any of many different shapes and sizes of jet pattern to achieve the desired force and area focus of the gas manipulation jet. Commercially available gas nozzle patterns include flat (comb), needle (dot), round and anulus, to mention a few.

Any appropriate valve may be used in accordance with the present disclosure. The gas manipulators may comprise a solenoid valve per nozzle or bank or set of nozzles. A solenoid valve may apply and terminate compressed gas supply to the nozzle(s) with very fast and repeatable response times. For example, each nozzle may be closely coupled to fast acting solenoid valve, such that each nozzle may be individually, and rapidly, activated and deactivated. Said solenoid valves may allow for ‘digital’ style control of the gas manipulators through the nozzles, wherein each nozzle is either in an ‘on’ state, or and ‘off’ state, with no intermediate positions.

The use of such fast acting solenoid valves may allow for very fine application control, wherein the amount of time a valve is open or closed for may be very precisely defined. This allows for the very exact timing and duration of the gas applied impingement force to be expelled by a manipulator in order to perform a desired fold/manipulation.

Providing a plurality of nozzles on a gas manipulator allows for gas to be delivered across a larger surface of a packaging product. If a flap is to be folded, it is desirable that the force applied to the flap is uniform across its surface. This prevents excessive twisting or distorting of the flap, which may cause uneven folding. Further, multiple nozzles may be able to provide a larger manipulation force than one nozzle alone. For example, if a packaging is made of a material that has a high manipulation resistance, multiple nozzles may be required to provide the manipulation force to manipulate the packaging. Alternatively, the flow rate or volume of the gas expelled by a nozzle may be adjusted to change the manipulation force. Conversely a low caliper packaging material exhibiting a low flexural stiffness may respond better to more evenly distributed and mild force (low pressure) that more uniform and even manipulation occurs without relying on the board stiffness to withstand pressure differences.

The gas manipulator of the manipulation device may be configured to apply gas pressure uniformly across the area of a flap. This may be achieved by calibrating the number of nozzles in a gas manipulator, as well as the nozzle locations, alignments, orientations and application profiles. As outlined above, applying pressure uniformly across the area of a flap that is being manipulated prevents twisting or distortion of the flap being folded. Excessive twisting or distortion can generate erratic results which is undesirable when fast and consistent processing of the packaging is required.

The first gas manipulator may be arranged at a first position within the manipulation device. The second gas manipulator may be arranged at a second position within the manipulation device. The plurality of gas manipulators, each with their nozzle arrangement, may be configured to be activated at different activation times. In some examples, each individual nozzle of a plurality of nozzles within a particular gas manipulator may be configured to be activated at a time different from the activation of a neighbouring nozzle in the same gas manipulator. Staggered operation of individual gas nozzles within a single gas manipulator may ensure a reliable and smooth movement of part of a product (e.g. a flap of a packaging) over the full range of movement.

Varying the gas manipulator positions in any of the aforementioned manners accommodates packaging of differing dimensions, foldable panel (flap) shapes, materials and/or calipers to be manipulated by the device in a highly flexible and swift manner. For example, when a new packaging format is to be manipulated, the adaptability of the gas manipulator(s) allows adequate re-orientation, re-inclination and re-distancing from the packaging pathway and the new packaging in itself. Adequate re-orientation, re-inclination and re-distancing may be achieved by varying the inclination of a gas manipulator by altering its position along one or more of the x-axis, y-axis and/or z-axis. Furthermore, varying the positions of individual nozzles within a single gas manipulator may allow more controlled manipulation of a packaging as it moves along the product pathway. As outlined above, this is advantageous over existing production lines that use mechanical components to manipulate packaging into a predefined state.

The manipulation device may comprise a compression belt arranged (for example: above the product pathway) for holding in place one or more flaps of a packaging on the transportation means (e.g. transport mechanism, conveyor or independent mover) subsequent to its manipulation. By using a compression belt following the manipulation of a packaging, the packaging may be held in its manipulated state while it is advanced to the output of the product pathway. For example, where packaging parts are manipulated, to be glued together after being folded towards each other, a compression belt may be used to ensure the manipulated state is held for a certain amount of time for the glue to cure.

The manipulation device may comprise a controller for controlling operation of the first and second gas manipulators. The controller may be configured to control operation of the nozzle(s) in the respective gas manipulators. The controller may be any suitable controller for controlling one or more functions of the manipulation device.

The manipulation device may comprise a plurality of gas manipulators. The controller may be configured to control the automated changeover and manipulation device setup, from one packaging format to another. The controller may be configures to control the gas pressures per gas manipulator, bank of nozzles and/or individual nozzles making up such; the automated positioning, inclination and orientation of gas manipulators and individual and/or sets of nozzles making up the gas manipulators and the operation of all of the gas manipulators. The controller may be configured to operate the gas manipulators—e.g. by operating the nozzles or valves—to expel pressurised gas. System setups, applied gas pressures, nozzle positions and activation sequences per packaging format, are developed and saved in the controller for recall and reuse each time the packaging format is produced. The setup and sequence may be further adjusted during a production run via the operator interface with the controller and either saved as a configuration update, as a new recipe or discarded. With appropriate machine vision feedback and an adaptive machine learning algorithm the sequences and parameters applied by the controller may be progressively adjusted for optimize performance, compensating for temperature, humidity and packaging material variations.

The controller may be used to activate different gas manipulators/nozzles to match the progress of the packaging along the production line. This means that the sequential folding/manipulation of a package can be finely tuned for specific manipulations to occur at specific points of the production line, dependent on the packaging style and/or user requirements.

The controller may be programmable to operate valves associated with nozzles of each gas manipulator. The use of fast acting solenoid valves in combination with the fact that said valves can be controlled by a programmable controller allows the production line to be finely ‘tuned’, and capable of fine pressure control for precise manipulations of packaging to be performed.

The controller may also be programmed to reconfigure the plurality of gas manipulators. The controller may be configured to adjust the locations, inclinations and/or orientations of (some or all of) the gas manipulators within the manipulation device—for example to reconfigured the device to be used with a different packaging type, size, material and/or caliper. The controller may be configured to adjust the location, inclination and/or orientation of the nozzles within gas manipulators. The controller may be configured to adjust the characteristics, supply pressures, operational timing, duration and activation/deactivation sequences of the nozzles.

The controller may be programmable to alter the position of one or more gas manipulators and/or individual or sub-group of nozzles along and/or around one or more x-axis, y-axis or z-axis, as defined with respect to the product pathway.

The controller may comprise memory storage. Said memory storage may store data in the form of pre-sets. Said pre-sets may comprise specific configurations for the positioning, gas pressure supply and operation of the gas manipulators and/or individual or sub-sets of nozzles. The controller may, optionally include, operating instructions, for assembling packaging of specific, pre-set/pre-configured dimensions. The controller may be capable of switching between different pre-sets when packaging at the input of the production line/product pathway is changed.

The manipulation device may comprise a pack transportation means to positively transport the pack in a predetermined manner through the manipulation device. The transportation means may be any device or mechanism known in the art for the single or series controlled linear transfer of objects. The transportation means may be a pusher, thruster, indexing mechanism, conveyor, levitating or rail mounted independent mover (i.e. linear drive). Use of an independent cart (linear drive) mover or levitating tile mover allows the product to be moved independently of other product along the product pathway.

The manipulation device may be for use in packaging beverage containers. It may be a beverage manipulation device. The gas manipulation device and associated methods as described above may be used within the beverage manufacture and packaging industry, alone and/or in combination with conventional methods.

Further according to the disclosure is a method for manipulating a packaging, for example using a manipulation device as described anywhere herein.

Further according to the disclosure is a method for manipulating a product comprising: moving a product from an input to an output of a manipulation device along a product pathway; operating a first and second gas manipulator to output pressurized gas to manipulate the product moving along the product pathway; wherein the first gas manipulator is associated with the product pathway, arranged in a first orientation with respect to the product pathway; and the second gas manipulator is associated with the product pathway, arranged in a second orientation with respect to the product pathway, the second orientation being different to the first orientation.

As will be understood by the skilled person, such a method provides the same advantages associated with the manipulation device.

Further, it will be understood that any of the features that may be used in combination with the manipulation device may also be used/incorporated with aforementioned method, where appropriate.

### BRIEF DESCRIPTION OF THE DRAWINGS

FIG. 1 illustrates a manipulation device, used for closing packaging using air folding, with a packaging product provided at the input of the device.

FIG. 2 shows the same device as shown in FIG. 1, demonstrating a first packaging closure step.

FIG. 3 shows the same device as FIGS. 1 and 2, demonstrating a second closure step.

FIG. 4 shows the same device as FIGS. 1 to 3, demonstrating a third closure step.

FIG. 5 shows the same device as FIGS. 1 to 4, demonstrating a final closure step.

FIG. 6 shows the same device as FIGS. 1 to 5, demonstrating a closed package being progressed to the output of the device.

FIGS. 7a to 7f show a detailed view of packaging closure steps undertaken by a manipulation device.

FIG. 8 shows an exemplary schematic of a manipulation device.

FIG. 9 shows a further exemplary schematic of a manipulation device, shown in relation to product packaging.

### DETAILED DESCRIPTION

The present disclosure relates to a manipulation device that can be used to manipulate a wide range of products.

In the present examples, the manipulation device is for manipulating packaging,, for example involving folding the packaging into a desired configuration. As outlined above, it will be appreciated that when the term manipulation is used, this may involve, without limitation, folding, wrapping, bending, latching, holding, pressing, inserting, twisting or the like of components, parts, flaps, panels, and the like, of packaging. Additionally, while the following examples relate to packaging, the present disclosure is not limited as such and the below comments apply equally to manipulation devices for manipulating other products.

The device may be incorporated into an existing production line or as a standalone device. The device may be used alone or in combination with conventional folding methods. The device may be used to manipulate a wide variety of packaging, wherein different packaging may require different degrees of manipulation, e.g. requiring different numbers of folds, and/or requiring differing forces to be manipulated into a desired state. In some of the below examples, the manipulation device is used for closing packaging, however it is to be understood that the device is not limited as such. In the examples, the same reference numerals will be used to refer to corresponding features shown in the Figures.

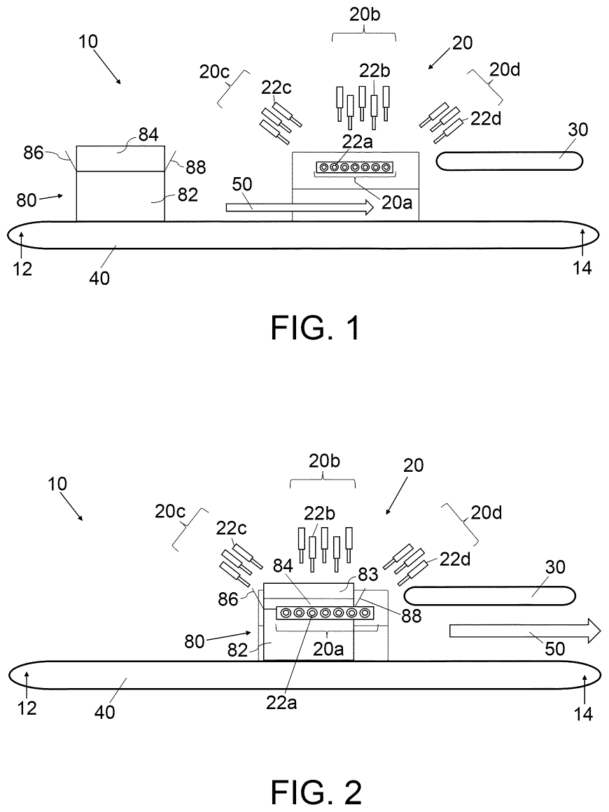

FIG. 1 shows a manipulation device 10, used for closing packaging 80 using air folding, with a packaging provided at the input 12 of the device. FIGS. 2 to 6 show the packaging product 80 of FIG. 1 sequentially moving through manipulation device 10 from input 12 to output 14, as will be described in further detail below.

FIG. 1 shows a partially assembled packaging 80 disposed at the input 12 of a conveyor 40 of the manipulation device 10.

The manipulation device has an input 12 and an output 14, defining a product pathway there between. A transportation device in the form of a conveyor 40 is configured to move a product—in this case packaging 80—from the input 12 to the output 14 in an aligned position and motion controlled manner. The conveyor 40 is an example of a transportation device, configured to move a product along the product pathway. Other examples of transportation devices may include conventional mechanical transfer mechanisms or independent levitating tile or rail mounted linear drive movers. In the present examples an arrow indicates the machine direction 50 of the manipulation device 10—that is the vector along which a packaging 80 moves from the input 12 to the output 14.

In this instance, prior to being input to the device 10, the packaging 80 has been assembled to the point wherein it now needs to be closed, with the body 82 of the packaging 80 having been formed, and closure flaps 83, 84, 86, 88 having yet to be manipulated. According to the direction of travel, flap 84 is an inner major flap with a score line associated with the right hand side of the (in this example) rectangular packaging; flap 83 is an outer major flap with a score line associated with the left hand side of the packaging; flap 88 is a leading minor flap with a score line associated with the leading front face of the packaging while flap 86 is a trailing minor flap with a score line associated with the trailing rear face of the packaging. It should be appreciated that the packaging flaps are foldable panels of material having a certain flexural stiffness. The flexural stiffness of a flap is a function the caliper and of the material, resins and coatings used in the construction of the flap. Being flexible, the flaps warp, buckle, bow, twist, bend and flex out of plane in response to point forces and/or non-uniformly applied pressures. It will be appreciated that packaging 80 may be input into the device 10 in any state of assembly in accordance with the user's requirements (e.g. as an entirely flat blank at the start of a box erecting operation). It will also be appreciated that while the packaging transportation device 40 in this instance is a conveyor, any suitable means of packaging transportation may be used to move packaging 80 in the desired machine direction 50, and in an aligned and motion controlled manner (e.g. known constant velocity). The device 10 may be configured to manipulate the packaging 80 in any manner required by the user. The conveyor 40 is configured to move the packaging 80 in a machine direction 50.

As the packaging 80 is moved by the conveyor 40 in the machine direction 50, it reaches the gas manipulator zone 20 of the device 10, comprising a plurality of gas manipulators 20a, 20b, 20c, 20d, disposed around the conveyor 40 at a clearance that allows the packaging 80 to pass therethrough while also providing enough clearance to accommodate the packaging state before closing and for any folding/manipulation operations to be performed. The manipulation device 10 of this example comprises five gas manipulators, four of which 20a, 20b, 20c, 20d are shown in FIG. 1. It will be appreciated that any number of gas manipulators may be used, dependent on the manipulations required to be performed by the device 10.

Each gas manipulator 20a, 20b, 20c, 20d comprises one or more nozzles 22a, 22b, 22c, 22d that deliver gas to a packaging target surface. The nozzles may be configured to output a gas flow, which may be a short pulse, or a prolonged jet of gas. It will be appreciated that the time taken to gas actuate the movement of a foldable panel (flap) may be in the order of a fractions of a second and hence the difference between a short pulse and a prolonged jet may be between a fraction of a millisecond to a few milliseconds, only. Should, for example, a hold in place function occur while a pack is transported out of the manipulation device, the gas jetting may continue for a fraction of a second, or more depending on the production rate (packages per minute). The number, orientation and gas output characteristics of the nozzles may be configured to provide a robust, reliable and non-damaging manipulation of the packaging product. This may require in some examples a plurality of nozzles in each gas manipulator with varying sizes, positions, inclinations, orientations and activation times and durations.

When the packaging 80 is moved in the machine direction 50 along the conveyor 40, it may be reoriented or located by an alignment device (not shown in FIG. 1). The alignment device may be located before the manipulation device of the present disclosure and may serve to orient the packaging product 80 so that it is always in the same orientation by the time it reaches the gas manipulators. As product packaging 80 may have fold lines in the specific areas in which it is desired for the packaging 80 to be folded, it is beneficial that they are aligned with the gas manipulators to provide the least resistance to folding when being manipulated by the gas manipulators. The alignment means may be any suitable alignment device, such as one or more guide rails or bumpers.

FIG. 2 shows the point in the manipulation process where the packaging 80 has reached a position along the conveyor 40 where it can be acted upon by the gas manipulators.

In the present example, upon reaching this stage, an initial manipulation is performed on the packaging 80 by a first gas manipulator 20a, wherein the first gas manipulator expels gas onto the first major flap 84 of the packaging 80, to fold the first major flap 84 from a generally vertical position into a horizontal position.

The terms “first”, “second” etc when used in relation to the gas manipulators are in no way limiting and are used purely for clarity when discussing this example. In other examples, other (differently positioned) gas manipulators may be referred to as the “first”, “second”, etc, gas manipulators.

Overlapping with this action, the second gas manipulator 20b expels gas to hold the first major flap 84 (and, later, the second major and first and second minor flaps) in a closed position.

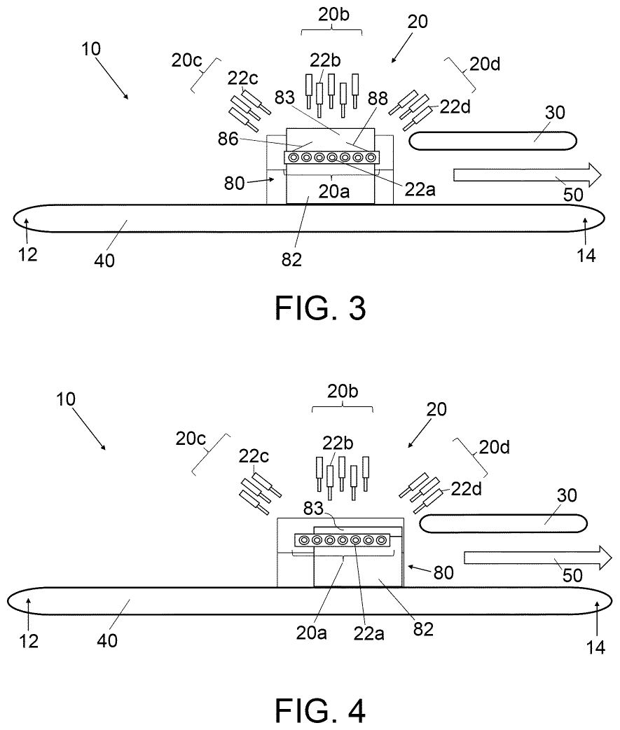

FIG. 3 shows the packaging 80 further advanced along the conveyor 40 than in FIG. 2. This point represents a further stage of manipulation. At this stage, the third and fourth gas manipulators 20c, 20d are activated, expelling gas on to the first and second minor flaps 86, 88 respectively. As the third and fourth gas manipulators 20c, 20d are activated and gas is expelled onto the first and second minor flaps 86, 88, these minor flaps 86, 88 are moved from generally vertical orientations to a horizontal orientations and laying on top of the previously actuated horizontal flap 84.

FIG. 4 shows the packaging 80 at yet a further advanced stage along the conveyor 40 than that shown in FIG. 3. A gas manipulator (not shown) opposing the first gas manipulator 20a is activated to expel gas onto the second major flap 83 of the packaging to move the second major flap 83 from a generally vertical orientation to a generally horizontal position, laying on top of the previously actuated horizontal flaps 83, 88 and 86, as shown, and thus closing the packaging. The user may configure the device 10 to begin the next manipulation in a sequence of manipulations before the previous manipulation has been completed. This is particularly advantageous in reducing the time taken to manipulate packaging 80 into a desired configuration. For example, the first and second minor flaps 86, 88 may begin to move to the fully closed position before the first major flap 84 has reached the fully closed position. Activating subsequent folding sequences before formerly initiated manipulations have been completed enables an assembly process wherein the transient and final result of follow-on manipulations tends to block the return of and retain the result of earlier folding operations from becoming un-done, i.e. Minor flaps 86 and 88 block the return and hold down flap 84, while flap 83 blocks the return and holds down all the preceding folded horizontal flaps (84, 86, 88).

Further, the gas manipulators 20a, 20b, 20c, 20d may be configured to ensure that gas is expelled onto a surface of the respective flap. That is, the gas manipulators 20a, 20b, 20c, 20d are arranged to avoid expelling gas through an aperture or into the packaging being erected or closed, that opposing pressures and/or escaping gas currents are not generated or induced, which may disturb or otherwise poorly influence the successful, repeatable folding operations.

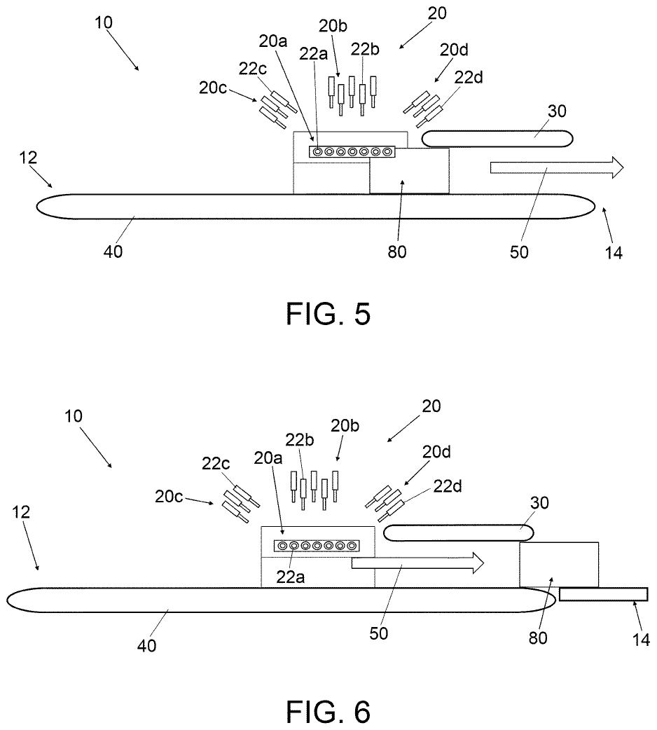

FIG. 5 shows packaging 80 being advanced along the machine direction 50 by the conveyor 40 to the compression belt 30 of the device 10. The compression belt 30 is provided at a clearance above the conveyor 40 to allow the packaging 80 to pass underneath, with the compression belt 30 being in contact with the top of the packaging 80 to ensure it remains closed as it is moved towards the output 14 of the device 10. The speed of the compression belt 30 is configured to be synchronised with the speed of the conveyor 40. This ensures that no shear force is created on the packaging 80 between the compression belt 30 and the conveyor 40. As some or all of the flaps 83, 84, 86, 88 may comprise adhesive to hold them in the closed position, or may be adhered in the closed position, the compression belt 30 may provide a means for applying pressure to the packaging 80 to assist with the adhering process (e.g. by assisting with the curing of a glue/adhesive that has been used to hold the flaps in place). The compression belt 30 may simply be provided to keep manipulated parts of the packaging in place while the product packaging 80 is moved towards the output 14 of the device 10. It will further be appreciated that the compression belt 30 may be positioned at another stage of the processing of the packaging, or may not be present at all in some devices.

FIG. 6 shows the packaging 80 in its manipulated state at the output 14 of the device. As outlined above, in this instance the manipulation device 10 has been used to close packaging 80 on a production line 40.

A controller (not shown) may be provided with the manipulation device 10. The controller may be part of a centralised control system. The controller may be a computer device. The controller may comprise a processor and data storage, and configured to receive and execute instructions to control operation of the manipulation device. The controller may be provided as part of the device 10, being wired or wirelessly connected to the device 10. The controller can be configured to control operation of the various components of the device, for example conveyor movement and gas manipulator operation. The controller may provide a means of synchronising one or more features of the device 10 with others. The controller may be used to programme the device to have certain user required characteristics, such as conveyor speed, compression belt speed, gas pressure, gas manipulator sequence, etc.

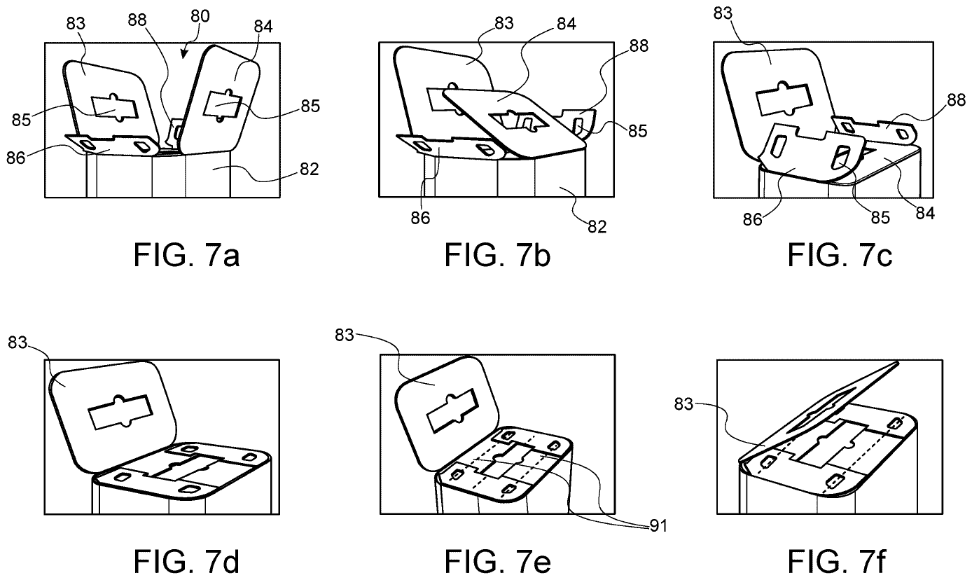

FIGS. 7a to 7f show a detailed view of the sequence described above in relation to FIGS. 1 to 6 wherein the manipulation device 10 is used to close a packaging 80. Within FIG. 7a, all flaps 83, 84, 86 and 88 are shown in a substantially upright, non-manipulated state. Within FIGS. 7b-c, the first major flap 84 (a major flap being a larger flap attached to the longer sides of the packaging) has been manipulated into the horizontal closed position by the gas manipulators. FIG. 7c,d then show the next stage in the sequence of manipulations for the closure procedure, wherein the first and second minor flaps 86, 88 (the minor flaps being those attached to the shorter sides of the packaging) are being folded into the horizontal closed position and laying flat on top of the formerly folded major flap 84.

FIGS. 7e and 7f show strips of adhesive 91 applied to flaps. Such strips of adhesive 91 may be particularly desired when flaps need to be glued to one another. In this example, strips of adhesive 91 are provided on both minor flaps 86 and 88, and on major flap 84. When the second major flap 83 is manipulated into its desired position, towards the previously manipulated (folded) flaps 84, 86, 88, the strips of adhesive may establish adherence of flap 84 to it in its final state. As outlined above, the adhesive may be a glue, which may take time to cure, ensuring the second major flap 83 is held in position once the packaging 80 is further moved to the output. To allow this adhesive time to cure and/or to apply additional pressure between the second major flap 83 and the strips of adhesive 91 while the glue cures, the assembled packaging 80 may be passed under the compression belt 30 (see FIG. 1, for example).

Although the adhesive has been shown as strips disposed on the outer surface of the first major flap (84), one skilled in the art will appreciate that adhesive may be applied at any appropriate time of stage during or before the folding sequence and to any area of the packaging (80) and in any desired manner, dependent upon the desired final configuration of the packaging (80). Application of the adhesive may be an additional step incorporated within the packaging process. Alternatively, the packaging (80) may be provided with or have adhesive applied to it prior to being further handled (e.g., assembled). Any suitable adhesive may be used to maintain the packaging or packaging parts in the desired state. Said adhesive may be selected based upon its open time, curing time, its strength once cured or commercial availability and cost.

FIG. 7f shows the last stage of the packaging 80 closing sequence, wherein the second major flap 83 is manipulated to the closed position, after which the packaging 80 moves to the output of the device (not shown).

As discussed previously, the gas manipulator device may be configured to avoid expelling gas onto regions of the flaps where apertures 85 may be present or into the body of the package being closed, in order to avoid any lost force or incur any counter gas flow or pressure effects which may undermine the desired flap folding operation. Measures to avoidance jetting through flap apertures, reliefs or cut outs and/or about flap edges into the pack may include use of multiple nozzles and sequenced pulses thereof configured to strategically follow the travel of the pack and the simultaneous arc of movement of any flap being manipulated. This may be associated with precise position, inclination and orientation settings of the said nozzles at the machine setup for a given packaging, along with fine, fast acting on/off control of when nozzles are activated, for what duration, in which sequence and at what gas pressure (each or collectively). It should be appreciated that due to the speed of folding operations achieved, though it may be and option, in the present example, the positions, inclinations and orientations of the nozzles making up the manipulation device may be fixed at the time of setup for each packaging format (type).

As outlined above, the manipulation device 10 may accommodate packaging 80 of different dimensions or packaging 80 that requires different manipulation sequences to provide the product desired by the user. For example, within the drinks manufacturing industry, a wide variety of packaging 80 may be used to package different products. The product to be packaged may be glass bottles or aluminium cans. Said bottles or cans come in a range of shapes, sizes, diameters and heights and may be arranged within any formation in which the manufacturer wishes to sell them (such as 1×3, 2×2, 2×3, 3×4, 4×6, etc.). Therefore, the manipulation device 10 may be reconfigurable to accommodate the different packaging required for each of these product groupings.

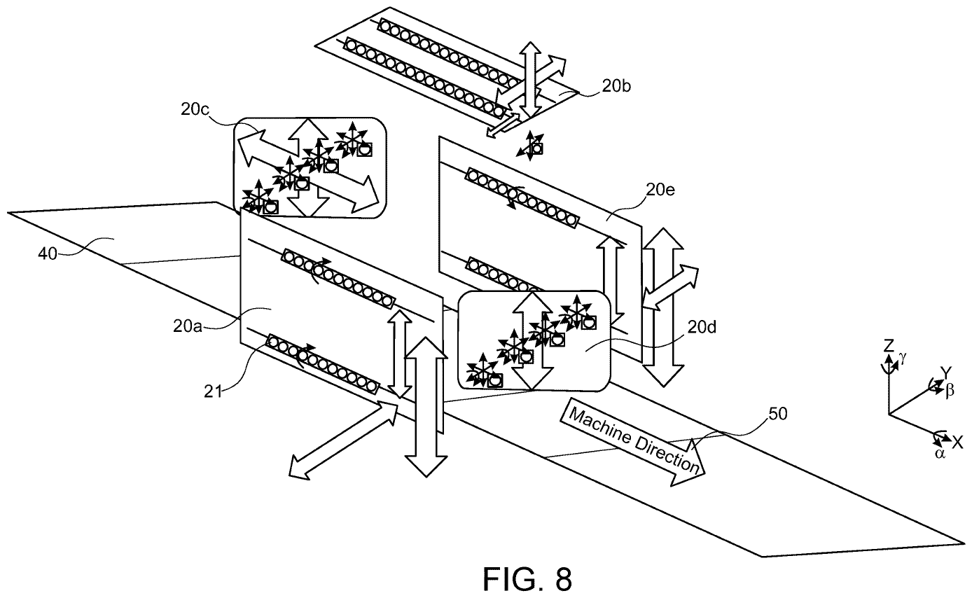

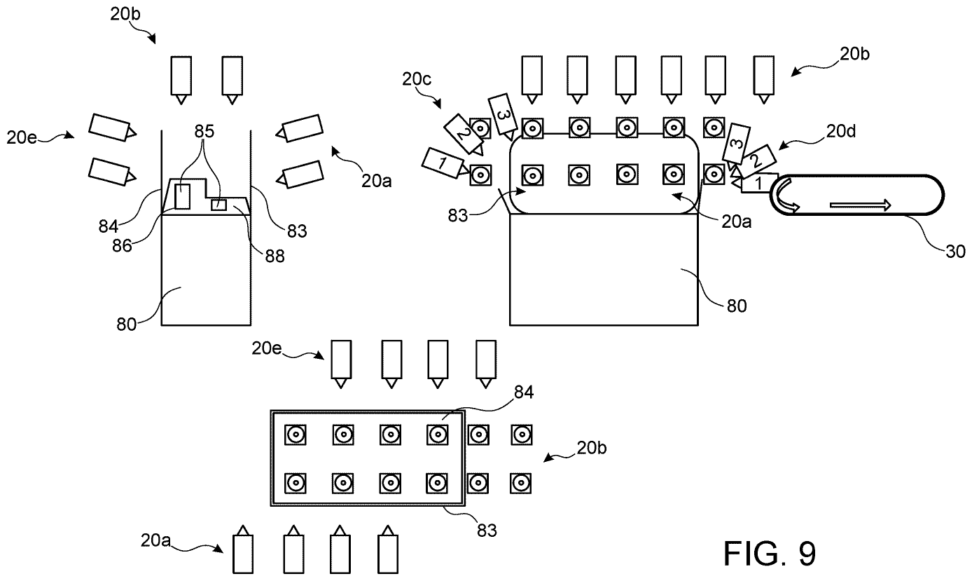

FIG. 8 provides a perspective view of a manipulation device and illustrates the reconfigurability of the manipulation device example. Arrows associated with each of the gas manipulators 20a, 20b, 20c, 20d, 20e indicate dimensions in which the respective manipulators can be moved to reconfigure the manipulators to accommodate packaging products of different dimensions. Certain manipulators can be moved horizontally parallel to the product pathway (x-axis), transversely to the product pathway (y-axis) and vertically (z-axis). Each gas manipulator is also shown to include a plurality of nozzles 21, arranged in one or more groups or banks.

A further execution example may comprise a series of machine frame and/or ceiling, wall or floor mounted single through multi-arm static robots equipped with end effectors comprising one or more sets of nozzles. In addition to major x, y, z axis robotic arm position, inclination and orientation setting of end effector nozzles, the one or more sets of nozzles per end effector may furthermore comprise means of fine position, inclination and orientation adjustment. Thus any means of linear side, telescoping actuator, and/or single or multi-jointed, single or multi-armed conventional robot may be used to effect the position, inclination and/or orientation setup of the one or more nozzles of sets of nozzles making up the manipulation device.

FIG. 9 shows a further exemplary schematic of a manipulation device, shown in relation to a packaging. FIG. 11 shows that gas manipulators may be offset in a direction along the product pathway to facilitate sequential manipulations as the packaging moves through the machine.

The present invention has been described above purely by way of example. Modifications in detail may be made to the present invention within the scope of the claims as appended hereto. Furthermore, features from one example may be combined with an alternative example unless such a combination is explicitly precluded.

1. A manipulation device for folding products comprising:
an input; and
an output;
the manipulation device defining a product pathway between the input and the output;
the manipulation device further comprising:
a transportation device configured to move a product along the product pathway;
a first gas manipulator associated with the product pathway, configured to output pressurized gas in a first orientation with respect to the product pathway for manipulating a product on the transportation device;
a second gas manipulator associated with the product pathway, configured to output pressurized gas in a second orientation with respect to the product pathway for manipulating the product on the transportation device, the second orientation being different to the first orientation.

2. The manipulation device of claim 1, wherein
the first gas manipulator is configured to perform a first manipulation of a product on the transportation device; and
the second gas manipulator is configured to perform a second manipulation of the product on the transportation device.

3. The manipulation device according to claim 1, wherein the product is a packaging product comprising a first and second flap; wherein the first manipulation is folding the first flap and the second manipulation is folding the second flap.

4. The manipulation device according to claim 1, wherein the first and second gas manipulators are configured to manipulate a product on the transportation device while in transit.

5. The manipulation device according to claim 1, wherein the first gas manipulator comprises a nozzle of the first gas manipulator configured to output pressurized gas and the second gas manipulator comprises a nozzle of the second gas manipulator configured to output pressurized gas.

6. The manipulation device of claim 1, wherein the first orientation is arranged in a plane parallel to the product pathway for folding a first flap of a product and the second orientation is arranged in a plane perpendicular to the product pathway for folding a second flap of the product in a direction perpendicular to that of the first flap.

7. The manipulation device of claim 1, wherein the first gas manipulator and the second gas manipulator are configured to output gas having different characteristics, the characteristics comprising at least one of: output pressure; output flowrate; output area; position, number of nozzles or outlets, duration of output and output cross-sectional shape.

8. The manipulation device of claim 1, wherein the manipulation device comprises a third gas manipulator and a fourth gas manipulator, wherein the third and fourth gas manipulators are configured to output pressurised gas for manipulating the product on the transportation device.

9. The manipulation device of claim 8, wherein the first and fourth gas manipulators are opposing and in a plane parallel to the product pathway, for manipulating a first pair of opposing flaps of a packaging on the transportation device; the second and third gas manipulators are opposing and in a plane perpendicular to the product pathway, for manipulating a second pair of opposing flaps of the packaging.

10. The manipulation device of claim 1, wherein the device is configured to sequentially operate gas manipulators for sequentially undertaking manipulation events on the product on the transportation device, for example sequentially folding corresponding flaps of a packaging on the transportation device, as the product moves from the input to the output.

11. The manipulation device of claim 1, wherein the output of pressurized gas is controlled by a valve, wherein the valve is a solenoid valve.

12. The manipulation device of claim 1, further comprising a controller for controlling the operation of the first and second gas manipulators.

13. The manipulation device of claim 1, wherein the first and/or second gas manipulators comprise a plurality of nozzles.

14. The manipulation device of claim 13, wherein the plurality of nozzles within a single gas manipulator have different locations with respect to the product pathway; and/or
have different orientations with respect to the product pathway; and/or,
are configured to output gas having different characteristics defined by at least one of: the nozzle type, the output pressure; the output flowrate; the output area; and the output cross-sectional shape.

15. A method for manipulating a product comprising:
moving a product from an input to an output of a manipulation device along a product pathway;
operating a first and second gas manipulator to output pressurized gas to manipulate the product moving along the product pathway; wherein
the first gas manipulator is associated with the product pathway, arranged in a first orientation with respect to the product pathway; and
the second gas manipulator is associated with the product pathway, arranged in a second orientation with respect to the product pathway, the second orientation being different to the first orientation.
